(19) United States
(12) Patent Application Publication
(10) Pub. No.: US 2008/0067028 A1
(43) Pub. Date: Mar. 20, 2008

(54) Magnetic clutch

(75) Inventors: Hiroyuki Nagaya, Kariya-city (JP); Kazuhiko Otsuka, Okazaki-city (JP); Fumiaki Kato, Okazaki-city (JP); Tomoyuki Hirai, Osaka (JP); Tohru Nakatsuka, Osaka (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); NIPPON PAINT CO., LTD., Osaka-shi (JP)

(21) Appl. No.: 11/902,074

(22) Filed: Sep. 18, 2007

(30) Foreign Application Priority Data
Sep. 19, 2006 (JP) 2006-252702

(51) Int. Cl. F16D 27/108

(52) U.S. Cl. 192/84.941

(57) ABSTRACT

A magnetic clutch 1 having a rotor 2, an armature 3 having a friction surface 31 disposed opposite and engaged by the friction surface 21 of the rotor 2, an electromagnetic coil 4 for attracting the armature 3 to the side of the rotor 2, and a rubber hub 5 for transmitting the rotational power to driven equipment. The rubber hub 5 is composed of an outer hub 51 fixed to the armature 3, an inner hub 52 connected to the driven equipment, and a rubber part 53 disposed between the outer hub 51 and the inner hub 52. On a surface of the armature 3, a corrosion-preventive coated film is formed by electrodeposition-coating. A powder coated film 6 having a function of preventing adhesion between the armature 3 and the rubber part 53 is formed on a surface of the outer hub 51, on a surface of the inner hub 52, and on a rubber seating surface 531 of the rubber part 53.

### TECHNICAL FIELD

The present invention relates to a magnetic clutch for transmitting rotational power, and interrupting rotational power.

### BACKGROUND ART

Conventionally, there are magnetic clutches for transmitting rotational power to a compressor for a vehicle air conditioner or the like and for interrupting the rotational power (see International Patent Publication No. WO03/069178, Japanese unexamined patent publications No. 08-114241 and 2005-180474). The magnetic clutch comprises a rotor having a friction surface which rotates, an armature also having a friction surface disposed opposite and engaged by the friction surface of the rotor, an electromagnetic coil which generates a magnetic force by current conduction and attracts the armature to the rotor side, and a rubber hub which transmits the rotational power of the armature to the compressor.

In addition, the rubber hub is disposed at a position sandwiching the armature between the rubber hub and the rotor. The armature is attracted to the side of the rotor or comes apart from the rotor, by switching the current conduction of the magnetic coil. In other words, the armature is attracted to the rotor side by its magnetic force during current conduction of the magnetic coil, and the armature separates from the rotor by a restoring force of a rubber part during noncurrent conduction of the electromagnetic coil. Thereby, the rotational power transmitted to the rotor is transmitted to the compressor through the armature and the rubber hub.

When the armature has separated from the rotor, the armature comes in contact with the rubber hub. At this time, the armature is configured so that a shock is suppressed by contacting a portion of the rubber hub. However, in a high-temperature environment, the armature occasionally adheres to the rubber part, when the armature has come in contact with a portion of the rubber. It is thought that this is due to an uncured component contained in an electrodeposition-coated film coating the armature and an uncured residual curing agent contained in a powder coated film coating the rubber part which melt due to high temperature, and thereby cause a chemical reaction.

In this case, there is a possiblity that the armature will not smoothly separate from the rubber hub, when current conduction is performed again in the electromagnetic coil. Accordingly, there is a possibility that the armature may not smoothly move towards the rotor side during current conduction of the electromagnetic coil, and as a result, the rotational power which should be transmitted to the compressor cannot be immediately transmitted, and thus, the function of the magnetic clutch is impaired.

Moreover, because an inner hub, an outer hub and the armature are generally composed of steel, which are required to be subjected to a corrosion-proof treatment.

In the corrosion-proof treatment, a phenol-based solvent coating material has been conventionally used. However, since the phenol-based solvent coating material contains a large amount of an organic solvent, there is a possibility that the solvent may adversely affect the environment. Therefore, the coating material is required to be changed to a coating material having a small content of solvent.

Accordingly, it is thought that an epoxy-based coating material having excellent corrosion resistance and containing no solvent be used. However, in the case of coating a joint of the magnetic clutch which repeats attachment and detachment, and transmits the power, melting of a coated film will occur due to an increase in temperature during the attachment and detachment, which occasionally becomes impossible to prevent adhesion between the rubber hub and the armature. This is because, both the components (mainly, an epoxy resin, a blocked isocyanate compound, and various kinds of pigments) composing an electrodeposition-coating material used for coating the armature part, and the components (an epoxy resin, a curing agent and a filler) composing a powder coating material used for coating the rubber part, use an epoxy resin.

In other words, when an electrodeposition-coated film is obtained by baking the electrodeposition-coating material, an unreacted component remains. Similarly, when a powder coated film is obtained by baking the powder coating material, an unreacted component remains. When both of the coated films are used in a high-temperature environment, in other words, in parts composing the joint of a magnetic clutch, avoidance of the problem of the above-described melting and a fundamental nature of the powder coating material are mutually contradictory.

It has been desired to develop a coating material whereby such mutually contradictory matters can be solved, and the adverse effect on the environment can also be solved at the same time.

As a powder coating material, specifically, a powder coating material having a high content of filler, such as a pigment (high PWC) is desired. The content of the pigment in an ordinary powder coating material is 20 to 30% by weight in many cases. Therefore, such a powder coating material is not appropriate as a material for coating the rubber part.

In Japanese Unexamined Patent Publication No. 2002-371226, a powder coating material having a pigment content of 50% by weight is disclosed. In the powder coating material disclosed in Japanese Unexamined Patent Publication No. 2002-371226, in order to achieve a pigment content of 50% by weight, it is essential that the vinyl copolymer containing an epoxy group contains an orthophosphoric diester group.

However, it is preferable that such a material indicating strong acidity not be used in the rubber hub of the magnetic clutch, since an unreacted compound containing a phosphoric group may generate corrosion in a metal part of a rubber hub in the magnetic clutch.

Moreover, considering the adhesive property of the rubber part, a coating material composition containing an acidic substance is not preferable. If the composition is coated on the magnetic clutch, the composition will not ensure the performance of the clutch.

### SUMMARY OF THE INVENTION

The present invention has been made to solve the above problems. An object thereof is to provide a magnetic clutch which can ensure a smooth operation, does not deteriorate a corrosion-preventive property, and is environmentally friendly.

The present invention provides a magnetic clutch comprising a rotor having a friction surface which rotates, an armature also having a friction surface disposed opposite and engaged by the friction surface of the rotor, an electromagnetic coil which generates a magnetic force and attracts the armature to a side of the rotor, and a rubber hub which is disposed so as to sandwich the armature between the rubber hub and the rotor to transmit rotational power from the armature to equipment to be driven;

the rubber hub is composed of an outer hub fixed to the armature, an inner hub connected to the driven equipment, and a rubber part disposed between the outer hub and the inner hub;

a corrosion-preventive film is formed by electrodeposition-coating on a surface of the armature;

a powder coated film having a function of preventing adhesion between the armature and the rubber part is formed on a surface of the outer hub, on a surface of the inner hub, and on a rubber seating surface of the rubber part which is in contact with the armature;

a powder coating material forming the powder coated film contains an epoxy resin having no acidic group, a curing agent, and a filler; and

a content of the filler is 40 to 60% by weight based on the total amount of the epoxy resin, the curing agent, and the filler.

Next, an action and effect of the present invention will be explained.

In the magnetic clutch, a corrosion-preventive coated film is formed on a surface of the armature by an electrodeposition-coating method, and the powder coated film is formed on a surface of the outer hub and on a surface of the inner hub. Thereby, corrosion resistance of the outer hub and inner hub can be ensured.

Moreover, the powder coated film is also formed on a rubber seating surface of the rubber part, and in the case where the rubber seating surface and the armature contact each other, they can be prevented from adhering to each other. Thereby, the armature can also separate smoothly from the rubber seating surface after the armature contacts the rubber seating surface, and smooth operation of the magnetic clutch can be ensured.

In addition, as the powder coated film having a function of preventing the adhesion between the armature and the rubber part is formed on a surface of the outer hub, on a surface of the inner hub, and on the rubber seating surface of the rubber part which is in contact with the armature, the formation thereof can be easily performed.

Moreover, the powder coating material forming the powder coated film contains no organic solvent, and it is easy to recycle a surplus coating material generated while the coating material is applied, and the amount of waste is reduced. Therefore, the coating material is environmentally friendly, and the magnetic clutch using the powder coated film is also environmentally friendly.

In addition, the powder coating material forming the powder coated film contains an epoxy resin, a curing agent, and filler, and a content of the filler is 40 to 60% by weight based on the total amount of the epoxy resin, the curing agent, and the filler. Thereby, the corrosion-preventive property in the outer hub and the inner hub can be ensured, and the adhesion of the armature and the rubber part can be sufficiently prevented.

Moreover, as the epoxy resin has no acidic group, acceleration of corrosion of the metal part of the rubber hub can be prevented.

As described above, according to the present invention, a magnetic clutch is provided, which can ensure a smooth operation, does not deteriorate the corrosion-preventive property, and is environmentally friendly.

### BRIEF DESCRIPTION OF THE DRAWINGS

FIG. 1 shows a partial explanatory view of a magnetic clutch during interrupting power in Example 1.

FIG. 2 shows a partial explanatory view of a magnetic clutch during transmitting power in Example 1.

FIG. 3 shows an explanatory view of a rubber hub in Example 1.

### DETAILED DESCRIPTION

In the above-described magnetic clutch of the present invention, the corrosion-preventive coated film formed on a surface of the armature can be, for example, an epoxy-based electrodeposition-coated film.

Moreover, examples of equipment to be driven, to which the rotational power of the armature in the magnetic clutch is transmitted, include a compressor for a refrigeration cycle for a vehicle, and so forth. In addition, the rotor in the magnetic clutch of the present invention can rotate by, for example, undergoing rotational power of a vehicle engine.

In addition, if the content of the filler is less than 40% by weight, the amount of the epoxy resin and the curing agent increases relatively, and consequently, the amount of the unreacted curing agent contained in the obtained powder coated film increases. Therefore, there is a possibility that it will be difficult to prevent adhesion between the armature and the rubber part. On the other hand, if the content is more than 60% by weight, in coating the powder coating material, there is a possibility that it will be difficult to melt the powder coating material, and the film-forming property will deteriorate. As a result, there is a possibility that it will be difficult to sufficiently form the powder coated film, and will not only be impossible to sufficiently ensure the corrosion resistance of the outer hub or the inner hub, but also be difficult to produce the powder coating material.

Moreover, when the epoxy resin has an acidic group, the corrosion of the metal part of the rubber hub is in danger of being accelerated. Conversely, when the epoxy resin has a basic group, the corrosion of the metal part of the rubber hub due to the substance containing an acidic group can be prevented.

In one embodiment of the present invention, it is preferable that the content of the filler is from 50 to 60% by weight based on the total amount of the epoxy resin, the curing agent, and the filler.

In this case, the adhesion between the armature and the rubber part can be prevented more effectively.

In another embodiment of the present invention, it is preferable that the epoxy resin is a bisphenol-type epoxy resin having an epoxy equivalent of 700 to 1,000 g/eq.

In this case, the corrosion-preventive property in the outer hub and the inner hub can be ensured, and the adhesion between the armature and the rubber part can be sufficiently prevented.

If the epoxy equivalent is less than 700 g/eq, even when the powder coated film is in a solid state, blocking can easily occur at ordinary temperature, and therefore, there is a possibility that it will be difficult to prevent adhesion to the armature. On the other hand, if the epoxy equivalent is more than 1,000 g/eq, when the temperature of the powder coating material applied becomes lower, the epoxy resin is difficult to melt, and the film-forming property deteriorates. As a result, there is a possibility that the durability or the corrosion-preventive property of the outer hub and the inner hub will be insufficient.

In another embodiment of the present invention, it is preferable that the curing agent is an amine-based curing agent and contains one or more kinds of compounds selected from imidazoles, imidazolines, dicyandiamides, dihydrazides and amine adducts, and a blending amount of the curing agent is from 1 to 10% by weight based on the total amount of the powder coating material.

In this case, the film-forming property of the powder coating material can be ensured, and the adhesion between the rubber part and the armature can be sufficiently prevented.

If the amount of the curing agent is 1% by weight, there is possibility that the film-forming property of the powder coated film will deteriorate, and consequently, the durability will deteriorate. As a result, there is possibility that the corrosion resistance of the outer hub and the inner hub will be difficult to be sufficiently ensured. It is thought that this is because the cross-linking becomes insufficient in the powder coated film, and the performance of the coated film deteriorates. On the other hand, if the amount of the curing agent is more than 10% by weight, there is possibility that it will be difficult to prevent adhesion to the armature. It is thought that this is caused by an adhesion phenomenon due to a reaction of unreacted curing agent in the powder coated film with the unreacted epoxy group in the corrosion-preventive coated film formed on a surface of the armature.

In yet another embodiment of the present invention, it is preferable that the powder coated film has a glass transition temperature measured using a tensile elastic-type dynamic viscoelasticity measuring apparatus is from 120 to 130° C.

In this case, it is easy to prevent the adhesion between the armature and the rubber part.

If the glass transition temperature is lower than 120° C., there is possibility that it will be difficult to sufficiently prevent adhesion between the armature and the rubber part. On the other hand, if the glass transition temperature is higher than 130° C., there is possibility that the film-forming property of the powder coated film will deteriorate, and it will be difficult to sufficiently ensure the corrosion resistance of the outer hub or the inner hub.

### EXAMPLES

### Example 1

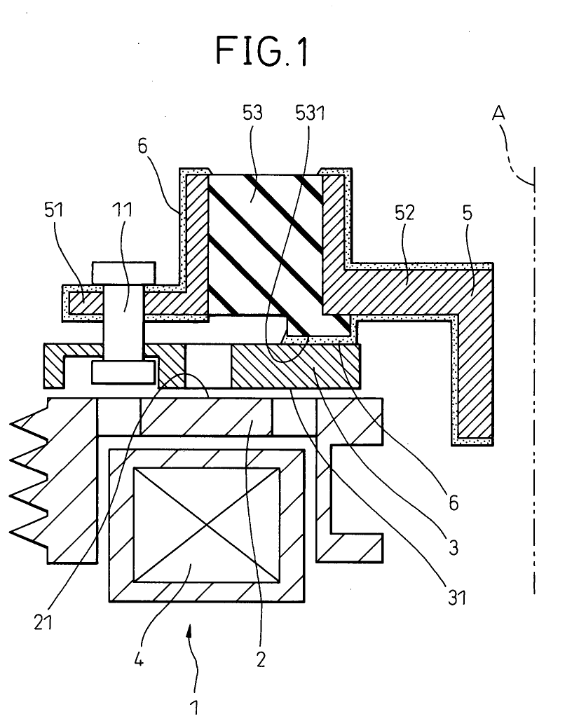

The magnetic clutch according to the example of the present invention will be described with reference to FIGS. 1 to 3.

The magnetic clutch 1 of this Example has a rotor 2, an armature 3, an electromagnetic coil 4 and a rubber hub 5, as shown in FIG. 1.

The rotor 2 can undergo rotational power and rotate, and has a friction surface 21. The armature 3 has a surface 31 to be rubbed which is disposed opposite to the fiction surface 21 of the rotor 2. The electromagnetic coil 4 generates a magnetic force by current conduction, and attracts the armature 3 to the side of the rotor 2. The rubber hub 5 is disposed at a position sandwiching the armature 3 between the rubber hub 5 and the rotor 2, and the rotational powder of the armature 3 is transmitted to driven equipment (not shown in FIG. 1).

The rubber hub 5 is composed of an outer hub 51 fixed to the armature 3, an inner hub 52 connected to the driven equipment, and a rubber part 53 disposed between the outer hub 51 and the inner hub 52.

The armature 3 is composed a corrosion-preventive coated film formed on a surface thereof by an electrodeposition-coating. A powder coated film 6 having a function of preventing adhesion between the armature 3 and the rubber part 53 is formed on a surface of the outer hub 51, on a surface of the inner hub 52, and on a rubber seating surface 531 of the rubber part 53 which is in contact with the armature 3.

The armature 3, the inner hub 52, and the outer hub 51 are composed of a steel material. The armature 3 is fixed to the outer hub 51 with a rivet 11, and is displaceable toward the side of the rotor 2 by elastic deformation of the rubber part 53.

In addition, on the surface of the armature 3, an epoxy-based electrodeposition-coated film is formed (not shown in FIG. 1). Moreover, at the surface of the rubber part 53 except the rubber seating surface 531, there is also a portion on which the powder coated film 6 is not formed.

In the magnetic clutch 1 of this Example, the rotor 2 rotates around a rotational axis A by undergoing rotational power of an engine.

As shown in FIG. 1, the rotor 2 idles, when the armature 3 separates from the rotor 2. In other words, when the electromagnetic coil 4 is not energized, the armature 3 separates from the rotor 2, and comes in contact with the rubber seating surface 531 of the rubber part 53. In this case, shock due to displacement of the armature 3 is absorbed by the rubber seating surface 531.

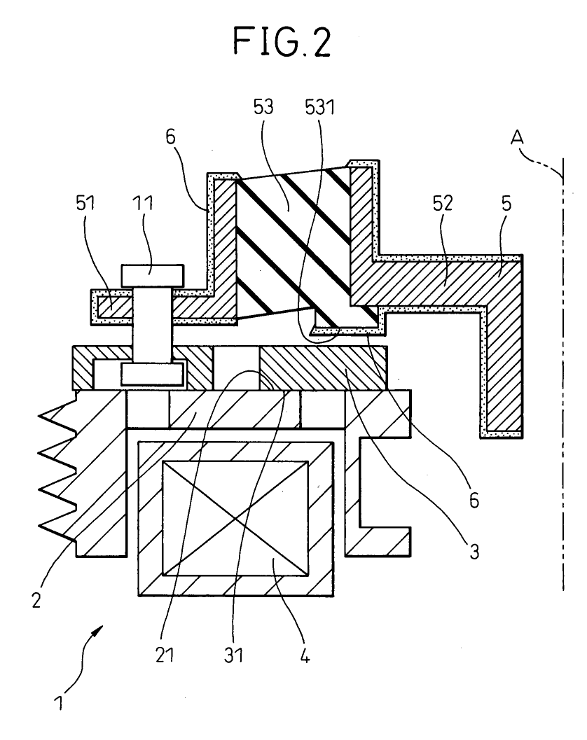

On the other hand, as shown in FIG. 2, when the electromagnetic coil 4 is energized, the armature 3 is attracted to the side of the electromagnetic coil 4. In this case, the rubber part 53 is elastically deformed, and allows the displacement of the armature 3. Then, the surface 31 (to be rubbed) of the armature 3 comes in contact with the friction surface 21 of the rotor 2, and the armature 3 rotates along with the rotor 2. The armature is fixed to the outer hub 51 by the rivet 11. Therefore, the rotation of the rotor 2 is transmitted to the outer hub 51 through the armature 3 and the rivet 11, and the rubber hub 5 rotates. Thereby, the driven equipment, such as a compressor fixed to the rubber hub 5 rotates.

The powder coating material forming the powder coated film 6 contains an epoxy resin having no acidic group, a curing agent and filler. The content of the filler is from 40 to 60% by weight, and more preferably from 50 to 60% by weight, based on the total amount of the epoxy resin, the curing agent and the filler.

As the filler, for example, a silica powder (Silica Stone Powder Maru A, manufactured by Marusen Kogyo Co., Ltd.), calcium carbonate (Super 2000, manufactured by Maruo Calcium Co., Ltd.), a talc (Talc PK-50, manufactured by Fuji Talc Industrial Co., Ltd.), a precipitating barium sulfate (Precipitating Barium Sulfate SS-50, manufactured by Sakai Chemical Industry Co., Ltd.), and so forth can be used. In addition, one or more kinds of these fillers can be mixed and added to the powder coating material.

Moreover, optionally, as a part of the filler, for example, carbon black (Carbon MA-100, manufactured by Mitsubishi Chemical Corporation) can be also blended.

The above-described epoxy resin is a bisphenol A type epoxy resin having an epoxy equivalent of 700 to 1,000 g/eq, more preferably, an epoxy equivalent of 800 to 1,000 g/eq, and includes, for example, a compound represented by the following general formula (1) which can be obtained by reacting bisphenol A and epihalohydrin.

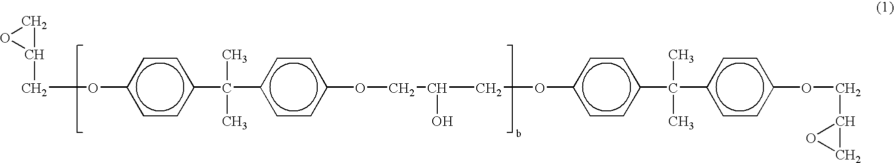

In the above formula (1), b represents an integer of 2 to 9. The epihalohydrin includes e.g. epichlorohydrin, epibromohydrin and so forth. The bisphenol A type epoxy represented by the above general formula (1) can be obtained by, for example, a method for polymerizing a low molecular weight epoxy resin and the bisphenol A in the presence of a catalyst by a two-step reaction, and so forth. The catalyst includes, for example, a tertiary amine such as triethylamine, an imidazole such as 2-methylimidazole, and a quaternary ammonium salt such as trimethylammonium chloride.

The curing agent is an amine-based curing agent, and contains one or more kinds of compounds selected from imidazoles, imidazolines, dicyandiamides, dihydrazides and amine adducts, and a blending amount of the curing agent is from 1 to 10% by weight based on the total amount of the powder coating material.

Specifically, for the curing agent, for example, the dicyandiamides include CG-1400 manufactured by PTI Japan Co., Ltd., the imidazoles include Curesol C11Z manufactured by Shikoku Kasei Co., Ltd., the imidazolines include Curesol 2PZL manufactured by Shikoku Kasei Co., Ltd., the acidic dihydrazides include ADH manufactured by Otsuka Chemical Co., Ltd., and the amines include 4,4′-diaminodiphenylmethane, 4,4′-diaminodiphenylsulfone and an aromatic amine made from one of these amines serving as a starting material (such as Tohto Amine TH-1000, manufactured by Tohto Kasei Co., Ltd. ). One kind of the curing agent, or two or more kinds of the curing agents can be added to the powder coating material.

A curing accelerator can be also blended in the powder coating material.

Moreover, in the powder coating material, as well as the above components, a flow control agent, an antifoamer, a fluid additive and so forth, which are known and generally used, can also be optionally blended.

In addition, the powder coated film 6 has a glass transition temperature measured using a tensile elastic-type dynamic viscoelasticity measuring apparatus is 120 to 130° C.

Next, an action and effect of this Example will be explained.

In the magnetic clutch 1, a corrosion-preventive coated film by electrodeposition-coating is formed on a surface of the armature 3, and the powder coated film 6 is formed on a surface of the outer hub 51 and on a surface of the inner hub 52. Thereby, the corrosion resistance of the outer hub 51 and the inner hub 52 can be ensured.

Moreover, on the rubber seating surface 531 of the rubber part 53, the powder coated film 6 is formed. Therefore, as shown in FIG. 2, when the rubber seating surface 531 and the armature 3 are contacted each other, both of them can be prevented from adhering to each other. Thereby, also after the armature 3 becomes in contact with the rubber seating surface 531, the armature 3 can separate smoothly from the rubber seating surface 531, and a smooth operation of the magnetic clutch 1 can be ensured.

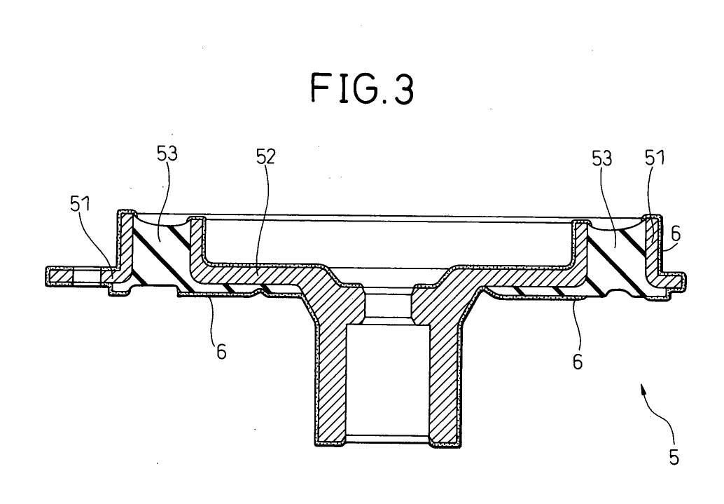

In addition, as shown in FIG. 1 and FIG. 3, since the powder coated film 6 having a function of preventing adhesion between the armature and the rubber part is formed on a surface of the outer hub 51, on a surface of the inner hub 52, and on a rubber seating surface 531 of the rubber part 53 which is in contact with the armature 3, the formation thereof can be easily performed.

Moreover, the powder coating material, which is applied on the surface of the outer hub 51, the surface of the inner hub 52, and the rubber seating surface 531 of the rubber part 53 being in contact with the armature 3 and forms the powder coated film 6, does not contain an organic solvent, and is easy for recovering and recycling. Therefore, the waste product thereof is little, and the coating material is environmentally friendly. Thus, the magnetic clutch 1 using the powder coated film 6 is environmentally friendly in its production process.

In addition, the powder coating material forming the powder coated film 6 contains an epoxy resin, a curing agent and filler, and the content of the filler is 40 to 60% by weight based on the total amount of the epoxy resin, the curing agent, and the filler. Therefore, the corrosion-preventive property of the outer hub 51 and the inner hub 52 can be ensured, and the adhesion between the armature 3 and the rubber part 53 can be sufficiently prevented.

Moreover, when the content of the filler is set to 50 to 60% by weight, the adhesion between the armature 3 and the rubber part 53 can be prevented more effectively.

In addition, as the epoxy resin is a bisphenol A type epoxy resin having an epoxy equivalent of 700 to 1,000 g/eq, the corrosion-preventive property of the outer hub 51 and the inner hub 52 can be ensured, and the adhesion between the armature 3 and the rubber part 53 can be sufficiently prevented.

The curing agent is an amine-based curing agent, and contains one or more kinds of compounds selected from imidazoles, imidazolines, dicyandiamides, dihydrazides and amine adducts. The blending amount of the curing agent is 1 to 10% by weight based on the total amount of the powder coating material. Therefore, the film-coating performance of the powder coating material can be ensured, and the adhesion between the rubber part 53 and the armature 3 can be sufficiently performed.

In addition, as the powder coated film 6 has a glass transition temperature measured by a tensile elastic-type dynamic viscoelasticity measuring apparatus is 120 to 130° C., the adhesion between the armature 3 and the rubber part 53 can be easily prevented.

As described above, according to this Example, a magnetic clutch can be provided, which ensures a smooth operation, does not deteriorate the corrosion-preventive property, and is environmentally friendly.

### Example 2

As shown in Tables 1 to 5, this Example is an example where the powder coating materials having various compositions were prepared, the powder coated films were formed with each of the powder coating materials, and then the properties of the coated films were evaluated.

In other words, the four kinds of bisphenol A type epoxy resins 1 to 4, four kinds of amine-based curing agents 1 to 4, and two kinds of fillers 1 and 2 were blended at the blending amounts shown in Tables 1 to 5, and Samples 1 to 18 and Comparative Samples 1 to 12 were made.

Moreover, in each of the Samples, 0.5 parts by weight of carbon black (Carbon MA-100, manufactured by Mitsubishi Chemical Co., Ltd.) was blended as a pigment, and 0.5 parts by weight of silicone oil (YF3919, manufactured by Toshiba Silicone Co., Ltd.) was blended as a surface conditioning agent.

As Epoxy resin 1, Epicoat 1005F (an epoxy equivalent of 1,000 g/eq, manufactured by Japan Epoxy Resin Co., Ltd.) was used.

As Epoxy resin 2, Epicoat 1003F (an epoxy equivalent of 750 g/eq, manufactured by Japan Epoxy Resin Co., Ltd.) was used.

As Epoxy resin 3, Epotohto YD-902 (an epoxy equivalent of 650 g/eq, manufactured by Tohto Kasei Co., Ltd.) was used.

As Epoxy resin 4, Epicoat 1006F (an epoxy equivalent of 1,100 g/eq, manufactured by Japan Epoxy Resins Co., Ltd.) was used.

Moreover, as Curing agent 1, Tohto Amine TH-1000 (manufactured by Tohto Kasei Co., Ltd.) was used.

As Curing agent 2, Curesol 2PZL (manufactured by Shikoku Kasei Corporation) was used.

As Curing agent 3, adipic acid dihydrazide (manufactured by Otsuka Chemical Co., Ltd.) was used.

As Curing agent 4, Dicyandiamide CG-1400 (manufactured by PTI Japan Co., Ltd.) was used.

Moreover, as Filler 1, sedimentation valium sulfate SS-50 (manufactured by Sakai Chemical Co., Ltd.) was used.

As Filler 2, Calcium Carbonate Super 2000 (manufactured by Maruo Calcium Co., Ltd.) was used.

The materials in which the each component was preliminarily mixed by Super Mixer (manufactured by Mitsui Miike Machinery Co., Ltd.) were melted and mixed by a melting kneader (Buss Cokneader, manufactured by Buss Co., Ltd.), milled and cooled by a press roller, and then roughly crushed to produce pellets. The pellets were atomized by a mechanical atomizer (“Atomizer KIIW-1 type”, manufactured by Fuji Paudal Co., Ltd.), and passed through a sieve of 150 mesh to obtain a powder coating composition having an average particle size of 25 to 35 μm.

Next, a dull steel plate (SPCC-SD) of 0.8 mm (thickness)×70 mm>150 mm was subjected to a chemical conversion treatment by using a phosphoric zinc treating agent (“Surfdine DP4000”, manufactured by Nippon Paint Co., Ltd.), and then the powder coating materials as respectively shown in Tables 1 to 5 were coated thereon at a cured film thickness of 60 μm by using a corona charging-type coating gun (“GX116”, manufactured by Parker Ionics Co., Ltd.), and thereby the powder coated films were formed.

Then, the coated objects on which the powder coated films were formed were baked at 150° C. for 10 minutes to obtain sample plates.

The performance on the following items of each of the coating plates obtained for evaluation was evaluated. The results are shown in Tables 1 to 5.

TABLE 1

| | | Sample 1 | Sample 2 | Sample 3 | Sample 4 | Sample 5 | Sample 6 |
|---|---|---|---|---|---|---|---|
| Formulation | Epoxy resin 1 | 100 | 100 | 100 | 100 | 100 | 100 |
| (Weight ratio) | Epoxy resin 2 | | | | | | |
| | Epoxy resin 3 | | | | | | |
| | Epoxy resin 4 | | | | | | |
| | Curing agent 1 | 16 | 16 | 16 | 8 | 8 | 8 |
| | Curing agent 2 | | | | 8 | 8 | 8 |
| | Curing agent 3 | | | | | | |
| | Curing agent 4 | | | | | | |
| | Filler 1 | 95 | 120 | 150 | 120 | | 90 |
| | Filler 2 | | | | | 79 | 30 |
| Content of filler | | 45% | 51% | 56% | 51% | 41% | 51% |
| Content of curing agent | | 8% | 7% | 6% | 7% | 8% | 7% |
| Epoxy equivalent (g/eq) | | 1000 | 1000 | 1000 | 1000 | 1000 | 1000 |
| Coated film | Glass | 127 | 127 | 129 | 127 | 127 | 128 |
| properties | transition | | | | | | |
| and coated film | point | | | | | | |
| quality | Adhesion | B | B | B | B | B | B |
| | Corrosion | B | B | B | B | B | B |
| | resistance | | | | | | |
| | Anti- | A-B | A | A | A | A-B | A |
| | adhesiveness | | | | | | |
| | Storage | B | B | B | B | B | B |
| | stability | | | | | | |

TABLE 2

| | | Sample 7 | Sample 8 | Sample 9 | Sample 10 | Sample 11 | Sample 12 | Sample 13 |
|---|---|---|---|---|---|---|---|---|
| Formulation | Epoxy resin 1 | 100 | 50 | 50 | 50 | 50 | 50 | 50 |
| (Weight ratio) | Epoxy resin 2 | | 50 | 50 | 50 | 50 | 50 | 50 |
| | Epoxy resin 3 | | | | | | | |
| | Epoxy resin 4 | | | | | | | |
| | Curing agent 1 | 6 | 6 | | | 3 | 3 | |
| | Curing agent 2 | | | | | | | 3 |
| | Curing agent 3 | | | 6 | | 3 | | 3 |
| | Curing agent 4 | | | | 6 | | 3 | |
| | Filler 1 | 106 | 106 | 106 | 106 | 106 | 106 | 106 |
| | Filler 2 | | | | | | | |
| Content of filler | | 50% | 50% | 50% | 50% | 50% | 50% | 50% |
| Content of curing agent | | 3% | 3% | 3% | 3% | 3% | 3% | 3% |
| Epoxy equivalent (g/eq) | | 1000 | 875 | 875 | 875 | 875 | 875 | 875 |
| Coated film | Glass | 128 | 126 | 127 | 127 | 126 | 126 | 128 |
| properties | transition | | | | | | | |
| and coated film | point | | | | | | | |
| quality | Adhesion | B | B | B | B | B | B | B |
| | Corrosion | B | B | B | B | B | B | B |
| | resistance | | | | | | | |
| | Anti- | A-B | A-B | A-B | A-B | A-B | A-B | A-B |
| | adhesiveness | | | | | | | |
| | Storage | B | B | B | B | B | B | B |
| | stability | | | | | | | |

TABLE 3

| | | Sample 14 | Sample 15 | Sample 16 | Sample 17 | Sample 18 |
|---|---|---|---|---|---|---|
| Formulation | Epoxy resin 1 | 50 | 60 | 80 | 80 | 80 |
| (Weight ratio) | Epoxy resin 2 | 50 | 40 | 20 | 20 | 20 |
| | Epoxy resin 3 | | | | | |
| | Epoxy resin 4 | | | | | |
| | Curing agent 1 | 4 | 4 | 4 | | |
| | Curing agent 2 | 3 | 3 | 3 | 3 | 3 |
| | Curing agent 3 | | | | 3 | |
| | Curing agent 4 | | | | | 3 |
| | Filler 1 | 106 | 106 | 106 | 106 | 106 |
| | Filler 2 | | | | | |
| Content of filler | | 50% | 50% | 50% | 50% | 50% |
| Content of curing agent | | 3% | 3% | 3% | 3% | 3% |
| Epoxy equivalent (g/eq) | | 875 | 900 | 950 | 950 | 950 |
| Coated film | Glass | 126 | 127 | 126 | 127 | 127 |
| properties | transition | | | | | |
| and coated film | point | | | | | |
| quality | Adhesion | B | B | B | B | B |
| | Corrosion | B | B | B | B | B |
| | resistance | | | | | |
| | Anti- | A-B | A-B | A-B | A-B | A-B |
| | adhesiveness | | | | | |
| | Storage | B | B | B | B | B |
| | stability | | | | | |

TABLE 4

| | | Comp. | Comp. | Comp. | Comp. | Comp. | Comp. | Comp. |
|---|---|---|---|---|---|---|---|---|
| | | Sample 1 | Sample 2 | Sample 3 | Sample 4 | Sample 5 | Sample 6 | Sample 7 |
| Formulation | Epoxy resin 1 | 100 | 100 | | | 50 | 100 | 100 |
| (Weight ratio) | Epoxy resin 2 | | | | | | | |
| | Epoxy resin 3 | | | 100 | | | | |
| | Epoxy resin 4 | | | | 100 | 50 | | |
| | Curing agent 1 | 16 | 16 | 16 | 16 | 16 | 1 | 25 |
| | Curing agent 2 | | | | | | | |
| | Curing agent 3 | | | | | | | |
| | Curing agent 4 | | | | | | | |
| | Filler 1 | 59 | 206 | 95 | 95 | 95 | 50 | 54 |
| | Filler 2 | | | | | | | |
| Content of filler | | 34% | 64% | 45% | 45% | 45% | 33% | 30% |
| Content of curing agent | | 9% | 5% | 8% | 8% | 8% | 0.7% | 14% |
| Epoxy equivalent (g/eq) | | 1000 | 1000 | 650 | 1135 | 1067 | 1000 | 1000 |
| Coated film | Glass | 127 | 133 | 116 | 132 | 132 | 120 | 115 |
| properties | transition | | | | | | | |
| and coated film | point | | | | | | | |
| quality | Adhesion | B | B | B | B | B | B | B |
| | Corrosion | B | D | B | D | D | B | B |
| | resistance | | | | | | | |
| | Anti- | D | B | C | B | B | D | D |
| | adhesiveness | | | | | | | |
| | Storage | B | B | D | B | B | B | B |
| | stability | | | | | | | |

TABLE 5

| | | Comp. | Comp. | Comp. | Comp. | Comp. |
|---|---|---|---|---|---|---|
| | | Sample 8 | Sample 9 | Sample 10 | Sample 11 | Sample 12 |
| Formulation | Epoxy resin 1 | 50 | 50 | 50 | 50 | 50 |
| (Weight ratio) | Epoxy resin 2 | 50 | 50 | 50 | 50 | 50 |
| | Epoxy resin 3 | | | | | |
| | Epoxy resin 4 | | | | | |
| | Curing agent 1 | 2 | 33 | 16 | | |
| | Curing agent 2 | | | 16 | 16 | 16 |
| | Curing agent 3 | | | | 10 | |
| | Curing agent 4 | | | | | 10 |
| | Filler 1 | 140 | 110 | 110 | 110 | 110 |
| | Filler 2 | | | | | |
| Content of filler | | 58% | 45% | 45% | 47% | 47% |
| Content of curing agent | | 0.8% | 14% | 13% | 11% | 11% |
| Epoxy equivalent (g/eq) | | 875 | 875 | 875 | 875 | 875 |
| Coated film | Glass | 129 | 125 | 125 | 125 | 125 |
| properties | transition | | | | | |
| and coated film | point | | | | | |
| quality | Adhesion | B | B | B | B | B |
| | Corrosion | D | B | B | B | B |
| | resistance | | | | | |
| | Anti- | B | D | D | C | C |
| | adhesiveness | | | | | |
| | Storage | B | B | B | B | B |
| | stability | | | | | |

Hereinafter, each of the evaluation methods will be explained.

Glass Transition Temperature

A coated film is formed in the above condition, and dynamic viscoelasticity is measured by a tensile elastic-type dynamic viscoelasticity measuring apparatus (Vibron), and the temperature providing the local maximum value when the temperature is changed is measured as the glass transition point.

Adhesion Property

According to a grid adhesion test of JIS D0202 4.15, 100 squares each having a size of 1 mm×1 mm are made at an effective coated surface (the steel part and rubber part), and a cellophane adhesive tape (trade name) is adhered onto the squares and then immediately separated orthogonally. The number of the residual squares where the cellophane adhesive tape is not completely peeled off is investigated. In the Tables, “B” represents that 100 squares out of the 100 squares were not peeled off.

Corrosion Resistance

According to a corrosion resistance test of JIS D0202 4.6, the crossly cut sample plate is subjected to a 5% salt water spray test at 35° C. for 384 hours, and after rinsing it with water, the sample plate is allowed to stand in a room for 2 hours, and then, a corrosion width from the crossly cut part is measured.

In the Tables, “B” represents that the corrosion width is 3 mm or less and the sample is acceptable, and “D” represents that the corrosion width is more than 3 mm and the sample is not acceptable.

Anti-Adhesiveness

After powder-coating on the rubber part 53, the rubber part 53 is fixed with the rivet 11 in the state of being in contact with the armature 3 subjected to the electrodeposition-coating, is allowed to stand in a thermostatic chamber at 120° C. for 72 hours, and then is taken out from the chamber. A load is applied to the rubber part 53 so that the outer hub 51 and the armature 3 are displaced to the side of the rotor 2 based on the inner hub 52, the displacement of the rubber part 53 is measured.

A sample where the load is not more than 130 N when the displacement of the rubber part 53 is 0.1 mm is determined to be acceptable. In the Tables, “A” represents, as an acceptable sample, the case where the load is not generated because the adhesion between the armature and the rubber part does not exist. “B” represents the case to be acceptable. In “C”, slight adhesion is detected, and the sample is not acceptable. “D” represents that strong adhesion is generated, and the sample is not acceptable.

Storage Stability

After storing the coating material in a thermostatic chamber at 40° C. for two weeks, it is confirmed whether a solid lump exists or not in the coating material. In the Tables, “B” represents the case where there is “no solid body” which is acceptable. “D” represents the case where there is “a solid body” which is not acceptable.

The results of the above evaluation were shown in Tables 1 to 5.

As shown in Tables 1 to 3, Samples 1 to 18 are excellent with regard to the adhesion property, corrosion resistance, anti-adhesiveness and storage stability. These Samples satisfy that the content of the filler is 40 to 60% by weight, the epoxy equivalent is 700 to 1,000 g/eq, the curing agent is 1 to 10% by weight, and the glass transition temperature is in a range of 120 to 130° C., in the powder coating material.

On the other hand, as shown in Tables 4, 5, Comparative Samples 1 to 12 are inferior to Samples 1 to 18 in terms of durability, anti-adhesiveness, and storage stability.

Specifically, if the amount of the filler is too small, the anti-adhesiveness is difficult to obtain, and if the amount of the filler is too large, the corrosion resistance deteriorates.

Moreover, if the epoxy equivalent is too low, the anti-adhesiveness and storage stability deteriorates, and if the epoxy equivalent is too high, the anti-adhesiveness is difficult to obtain.

We claim:

1. A magnetic clutch comprising a rotor having a friction surface which undergoes rotational power and rotates, an armature having a surface to be rubbed which is disposed opposite to the friction surface of the rotor, an electromagnetic coil which generates a magnetic force by current conduction and attracts the armature to a side of the rotor, and a rubber hub which is disposed at a position sandwiching the armature between the rubber hub and the rotor and transmits rotational power of the armature to driven equipment, wherein:
the rubber hub is composed of an outer hub fixed to the armature, an inner hub connected to the driven equipment, and a rubber part disposed between the outer hub and the inner hub;
a corrosion-preventive coated film by electrodeposition-coating is formed on a surface of the armature;
a powder coated film having a function of preventing adhesion between the armature and the rubber part is formed on a surface of the outer hub, on a surface of the inner hub, and on a rubber seating surface of the rubber part which is in contact with the armature;
a powder coating material forming the powder coated film contains an epoxy resin having no acidic group, a curing agent, and a filler; and
a content of the filler is 40 to 60% by weight based on the total amount of the epoxy resin, the curing agent, and the filler.

2. The magnetic clutch according to claim 1, wherein the content of the filler is from 50 to 60% by weight based on the total amount of the epoxy resin, the curing agent, and the filler.

3. The magnetic clutch according to claim 1, wherein the epoxy resin is a bisphenol-type epoxy resin having an epoxy equivalent of 700 to 1,000 g/eq.

4. The magnetic clutch according to claim 1, wherein the curing agent contains as an amine-based curing agent one or more kinds of compounds selected from imidazoles, imidazolines, dicyandiamides, dihydrazides and amine adducts, and a loading amount of the curing agent is 1 to 10% by weight based on the total amount of the powder coating material.

5. The magnetic clutch according to claim 1, wherein the powder coated film has a glass transition temperature measured by a tensile elastic-type dynamic viscoelasticity measuring apparatus is 120 to 130° C.
